(19) United States
(12) Patent Application Publication
(10) Pub. No.: US 2018/0215653 A1
(43) Pub. Date: Aug. 2, 2018

(54) GLASS COMPOSITION FOR CHEMICALLY STRENGTHENED ALKALI-ALUMINOSILICATE GLASS AND METHOD FOR THE MANUFACTURE THEREOF WITH SHORTENED ION EXCHANGE TIMES

(71) Applicant: KORNERSTONE MATERIALS TECHNOLOGY COMPANY, LTD., FUZHOU (CN)

(72) Inventors: Yuanjie Ding, Fuzhou (CN); Yijun Chen, Fuzhou (CN)

(21) Appl. No.: 15/747,601

(22) PCT Filed: Aug. 26, 2015
(86) PCT No.: PCT/CN2015/088132

§ 371 Date: Jan. 25, 2018

(51) Int. Cl. C03C 3/091; C03C 4/18; C03C 21/00; C03B 17/06; C03B 18/02; C03B 25/02

(52) U.S. Cl. CPC C03C 3/091; C03C 4/18; C03C 21/002; C03C 2204/00; C03B 18/02; C03B 25/025; C03B 17/064

(57) ABSTRACT

A glass composition for producing chemically strengthened alkali-aluminosilicate glass and a method for manufacturing the chemically strengthened alkali-aluminosilicate glass. The chemically strengthened alkali-aluminosilicate glass is suitable for use as high-strength cover glass for touch displays, solar cell cover glass and laminated safety glass, and is produced in a shorter amount of time.

### FIELD OF THE INVENTION

The present invention relates to chemically strengthened alkali-aluminosilicate glass, as well as compositions and methods for manufacturing and using the same.

### BACKGROUND

Chemically strengthened glass is typically significantly stronger than annealed glass due to the glass composition and the chemical strengthening process used to manufacture the glass. Such chemical strengthening processes can be used to strengthen glass of all sizes and shapes without creating optical distortion which enables the production of thin, small, and complex-shaped glass samples that are not capable of being tempered thermally. These properties have made chemically strengthened glass, and more specifically, chemically strengthened alkali-aluminosilicate glass, a popular and widely used choice for consumer mobile electronic devices such as smart phones, tablets and notepads.

The chemical strengthening processes typically include an ion exchange process. In such ion exchange processes, the glass is placed in a molten salt containing ions having a larger ionic radius than the ions present in the glass, such that the smaller ions present in the glass are replaced by larger ions from the heated solution. Typically, potassium ions in the molten salt replace smaller sodium ions present in the glass. The replacement of the smaller sodium ions present in the glass by larger potassium ions from the heated solution results in the formation of a compressive stress layer on both surfaces of the glass and a central tension zone sandwiched between the compressive stress layers. The tensile stress (“CT”) of the central tension zone (typically expressed in megapascals (MPa)) is related to the compressive stress (“CS”) of the compressive stress layer (also typically expressed in megapascals), and the depth of the compressive stress layer (“DOL”) by the following equation:

CT=CS×DOL/(t−2DOL)

where t is the thickness of the glass.

The current specifications for glass with a thickness of 0.7 mm is a depth of layer of about 40 μM, a compressive stress of not less than 650 MPa, and a tensile stress of the central tension zone of less than 60 MPa. Indeed, the tensile stress of the central tension zone should be kept within about 60-70 MPa to ensure a good cutting yield.

For use as cover glass for a touch display, it is desirable to increase the resistance of the glass to scratches and impaction damage. This can be accomplished by increasing the compressive stress and the depth of the compressive stress layer. However, to keep the tensile stress of the central tension zone within an acceptable range, an increase in both the compressive stress and the depth of the compressive stress layer undesirably results in an increase in the thickness of the glass.

Also, it is desirable for cover glass to be as thin as possible. However, since the tensile stress of the central tension zone increases as the thickness of the glass decreases, it is difficult to maintain an acceptable tensile stress of the central tension zone while also maintaining a high compressive stress and a high depth of the compressive stress layer. In such instances, it is generally desirable to have the ratio of compressive stress to depth of layer (CS/DOL) as high as possible.

The duration of the chemical strengthening process is a key factor in the manufacturing cost of chemically strengthened glass. Generally, the duration of the ion exchange process must be extended to increase the depth of the compressive stress layer. Shorter ion exchange times, however, are usually desired. The shorter the ion exchange time, the more competitive the production line and process. The ion exchange time is controlled by reaction temperature and ion diffusion rate. Decreasing the temperature can avoid warping, but increase the ion exchange time. Keeping the glass sheet at higher temperatures may increase the ion diffusion rate, but leads to warping and structural relaxation, which in turn can lead to a decrease in compressive stress. Thus, conducting the ion exchange process at a higher temperature may shorten the ion exchange time but has other undesirable results.

The chemical strengthening process can be performed in two ways: (1) the piece process and (2) the one glass solution (OGS) process. The piece process involves cutting a piece of glass into the final size to be used, and then drilling, grinding, beveling, and polishing the individual pieces. The processed pieces are then placed in molten potassium salt for chemical strengthening. The smaller sized pieces provide greater control over temperature and molten salt concentration. Moreover, the edges on both sides of the pieces can be chemically strengthened. Thus, high strength and a low rate of warping can be achieved, leading to a high yield.

In contrast, the OGS process involves strengthening the full sheet of glass first, adding touch sensors and printed circuits on the glass surface, then scribing the glass and finally cutting the glass. Compared to the piece process, a larger furnace is typically required in the OGS process. The way the glass is handled and placed may lead to warping of the glass or breakage. In the OGS process, the CS on the chemically strengthened glass surface facilitates resistance to surface damage, but may make it more difficult to cut the glass. When the CT is too high, a scribing wheel used to cut the glass may cause the glass to crack, chip or break when it enters the CT zone. The scribing edges and sides cannot be fully chemically strengthened in the OGS process, so the strength of glass made by the OGS process is generally lower than glass made by the piece process. Despite the difficulties associated with the OGS process, the cost-effectiveness and production efficiency of the OGS process are superior to the piece process.

As chemically strengthened glass becomes thinner and stronger, it becomes more difficult to maintain a high DOL and a high CS without increasing the CT. A chemically strengthened glass that is thin, with a high CS and controlled CT, and that is produced with shortened ion exchange times is desired.

### SUMMARY

A chemically strengthened alkali-aluminosilicate glass is presented herein.

According to several exemplary embodiments, the ion exchangeable glass for producing chemically strengthened alkali-aluminosilicate glass has a composition that includes in mole percent (mol %) on an oxide basis:

from about 63.0% to about 68.0% of silicon dioxide (SiO₂),

from about 12.0% to about 16.0% of aluminum oxide (Al₂O₃),

from about 10.0% to about 15.0% of sodium oxide (Na₂O),

from about 2.0% to about 6.0% of boron trioxide (B₂O₃),

from about 0% to about 6.0% of potassium oxide (K₂O),

from about 0% to about 3.0% of magnesium oxide (MgO), and

from about 0% to about 1.5% of calcium oxide (CaO)

wherein 28% is <Al₂O₃+B₂O₃+Na₂O<33%,

wherein (B₂O₃+Na₂O+K₂O)/Al₂O₃ is >1, and

wherein (B₂O₃+CaO)/MgO is >1.

### DETAILED DESCRIPTION

The term “about” indicates a range which includes ±5% when used to describe a single number. When applied to a range, the term “about” indicates that the range includes −5% of a numerical lower boundary and +5% of an upper numerical boundary, unless the lower boundary is 0. For example, a range of from about 100° C. to about 200° C., includes a range from 95° C. to 210° C. However, when the term “about” modifies a percentage, then the term means±1% of the number or numerical boundaries, unless the lower boundary is 0%. Thus, a range of 5-10%, includes 4-11%. A range of 0-5%, includes 0-6%.

The phrase “in mol percent on an oxide basis” or “in mol % on an oxide basis” refers to the percentage of moles of the oxide to the total number of moles in the glass. It is understood that the total number of mol percent in the glass always adds up to and never exceeds 100%.

According to several exemplary embodiments, the present invention provides an ion exchangeable glass for producing chemically strengthened alkali-aluminosilicate glass having a compressive stress layer with high compressive stress (CS), a high depth of layer (DOL), and a controlled tensile stress (CT) of the central tension zone. The higher CS together with the high DOL and controlled CT is obtained through a chemical strengthening process in which sodium ions on the glass surface are replaced by larger potassium ions. A lower CT is beneficial for glass finishing since the yield of the scribing process is increased. Also, a glass surface with a higher CS yields a stronger glass that can withstand increased external impaction forces. According to several exemplary embodiments, the chemically strengthened glass has a CS of more than 750 MPa, a DOL of up to about 45 μm, a CT of no more than 70 MPa and a thickness of up to about 0.7 mm.

According to several exemplary embodiments, the ion exchangeable glass for producing chemically strengthened alkali-aluminosilicate glass has a composition that includes in mole percent (mol %) on an oxide basis:

from about 63.0% to about 68.0% of silicon dioxide (SiO₂),

from about 12.0% to about 16.0% of aluminum oxide (Al₂O₃),

from about 10.0% to about 15.0% of sodium oxide (Na₂O),

from about 2.0% to about 6.0% of boron trioxide (B₂O₃),

from about 0% to about 6.0% of potassium oxide (K₂O),

from about 0% to about 3.0% of magnesium oxide (MgO), and

from about 0% to about 1.5% of calcium oxide (CaO)

wherein 28% is <Al₂O₃+B₂O₃+Na₂O<33%,

wherein (B₂O₃+Na₂O+K₂O)/Al₂O₃ is >1, and

wherein (B₂O₃+CaO)/MgO is >1.

According to several exemplary embodiments, the ion exchangeable glass for producing chemically strengthened alkali-aluminosilicate glass has a composition that includes from about 63.0 mol % to about 68.0 mol % of silicon dioxide (SiO₂). Silicon dioxide is the largest single component of the alkali-aluminosilicate glass and forms the matrix of the glass. Silicon dioxide also serves as a structural coordinator of the glass and aids formability, rigidity and chemical durability to the glass. Glass viscosity is enhanced when silicon dioxide is present in the above recited range. At concentrations above 68.0 mol %, silicon dioxide raises the melting temperature of the glass composition, which may detrimentally cause the liquidus temperature to increase substantially in glasses having high alkali or alkaline metal oxide concentrations.

According to several exemplary embodiments, the ion exchangeable glass for producing chemically strengthened alkali-aluminosilicate glass has a composition that includes from about 12.0 mol % to about 16.0 mol % of aluminum oxide (Al₂O₃). Glass viscosity is enhanced when aluminum oxide is present in these amounts. At concentrations of aluminum oxide that are more than 16.0 mol %, the viscosity of the glass becomes prohibitively high and tends to devitrify the glass. The liquidus temperature may also become too high to perform a continuous sheet forming process. Thus, the total content of flux oxides (e.g., sodium, potassium, boron, magnesium, and calcium oxides) in the glass composition should be greater than the content of aluminum oxide. The melting temperature of the glass composition can also be decreased by the addition of flux oxides. According to several exemplary embodiments, the melting temperature of the glass is maintained below 1690° C.

According to several exemplary embodiments, the ion exchangeable glass for producing chemically strengthened alkali-aluminosilicate glass has a composition that includes from about 2.0 mol % to about 6.0 mol % of boron trioxide (B₂O₃). Boron trioxide serves as a flux oxide as well as a glass coordinator. Together with silicon, trivalent boron acts as a network-forming element and increases the glass formability. The B—O bond usually occurs in oxide glasses with coordination numbers of 3 and 4, which is of high field strength and indicates that the B—O bond is very strong. However, the bonds between the boron oxide groups are generally very weak at high temperatures, which is different from silicon oxide. The viscosity of boron trioxide at high temperatures is much lower than that of silica, so that boron trioxide can act as a very efficient flux oxide.

Alkali metal oxides serve as aids in achieving low liquidus temperatures and low melting temperatures. According to several exemplary embodiments, the ion exchangeable glass for producing chemically strengthened alkali-aluminosilicate glass has a composition that includes alkali metal oxides, namely sodium oxide (Na₂O) and potassium oxide (K₂O). To ensure sufficient strength and avoid side effects caused by too much alkali metal oxide, sodium oxide and potassium oxide are present in the glass composition in the amounts described below. According to several exemplary embodiments, to achieve effective melting, the total content of boron trioxide, sodium oxide, and potassium oxide in the glass composition is greater than the content of aluminum oxide. According to several exemplary embodiments, the ion exchangeable glass for producing chemically strengthened alkali-aluminosilicate glass has a composition that includes a ratio of the combined total content of boron trioxide, sodium oxide and potassium oxide to the total content of aluminum oxide of greater than 1.

According to several exemplary embodiments, the ion exchangeable glass for producing chemically strengthened alkali-aluminosilicate glass has a composition that includes from about 10.0 mol % to about 15.0 mol % of sodium oxide. Sodium oxide is used to enable successful ion exchange. In order to permit sufficient ion exchange to produce substantially enhanced glass strength, sodium oxide is included in the glass composition in the concentrations set forth above.

According to several exemplary embodiments, the ion exchangeable glass for producing chemically strengthened alkali-aluminosilicate glass has a composition that includes from 0 mol % to about 6.0 mol % of potassium oxide. Potassium oxide increases the depth of the ion exchange layer. The radius of alkali metal ions, especially of potassium ions is larger than that of other oxides, which can reduce glass strength and increase the expansion coefficient.

Both magnesium oxide (MgO) and calcium oxide (CaO) are alkaline earth metal oxides that can serve as flux oxides. According to several exemplary embodiments, the ion exchangeable glass for producing chemically strengthened alkali-aluminosilicate glass has a composition that includes from 0 mol % to about 3.0 mol % of magnesium oxide. Since the glass composition contains from about 12.0 mol % to about 16.0 mol % of aluminum oxide, the amounts of alkaline earth metal oxides in the glass composition is controlled so as to not detrimentally increase liquidus temperature and viscosity at high temperatures. Therefore, magnesium oxide is present in the glass composition at no more than about 3.0 mol %. To avoid side effects caused by magnesium oxide, boron oxide and calcium oxide can be added to control the increase of liquidus temperature and the viscosity. According to several exemplary embodiments, the total content of boron trioxide and calcium oxide in the glass composition is greater than the content of magnesium oxide. According to several exemplary embodiments, the ion exchangeable glass for producing chemically strengthened alkali-aluminosilicate glass has a composition that includes a ratio of the combined total content of boron trioxide and calcium oxide to the total content of magnesium oxide of greater than 1.

According to several exemplary embodiments, the ion exchangeable glass for producing chemically strengthened alkali-aluminosilicate glass has a composition that includes from 0 mol % to about 1.5 mol % of calcium oxide. Excessive calcium oxide reduces the ion exchange rate, and requires more ion exchange time or a higher temperature to achieve a deep depth of the ion exchange layer.

According to several exemplary embodiments, the ion exchangeable glass for producing chemically strengthened alkali-aluminosilicate glass has a composition that includes a total content of aluminum oxide, boron trioxide, and sodium oxide of from about 28.0 mol % to about 33.0 mol %.

According to several exemplary embodiments of the ion exchangeable glass for producing chemically strengthened alkali-aluminosilicate glass described above, the glass has a liquidus temperature (the temperature at which a crystal is first observed) of at least about 950° C. According to several exemplary embodiments of the ion exchangeable glass for producing chemically strengthened alkali-aluminosilicate glass described above, the glass has a liquidus temperature of at least about 980° C. According to several exemplary embodiments of the ion exchangeable glass for producing chemically strengthened alkali-aluminosilicate glass described above, the glass has a liquidus temperature of at least about 1000° C. According to several exemplary embodiments of the ion exchangeable glass for producing chemically strengthened alkali-aluminosilicate glass described above, the glass has a liquidus temperature of up to about 1100° C. According to several exemplary embodiments of the ion exchangeable glass for producing chemically strengthened alkali-aluminosilicate glass described above, the glass has a liquidus temperature of from about 950° C. to about 1100° C.

According to several exemplary embodiments, the present invention provides a method for manufacturing a chemically strengthened alkali-aluminosilicate glass. According to several exemplary embodiments, the method includes:

mixing and melting the components to form a homogenous glass melt;

shaping the glass using the overflow down-draw method, the floating method and combinations thereof;

annealing the glass; and

chemically strengthening the glass by ion exchange.

According to several exemplary embodiments, the manufacture of the chemically strengthened alkali-aluminosilicate glass, may be carried out using conventional overflow down-draw methods which are well known to those of ordinary skill in the art and which customarily include a directly or indirectly heated precious metal system consisting of a homogenization device, a device to lower the bubble content by means of fining (refiner), a device for cooling and thermal homogenization, a distribution device and other devices. The floating method includes floating molten glass on a bed of molten metal, typically tin, resulting in glass that is very flat and has a uniform thickness.

According to several exemplary embodiments of the method for manufacturing a chemically strengthened alkali-aluminosilicate glass described above, the ion-exchangeable glass composition is melted for up to about 12 hours at about 1690° C. According to several exemplary embodiments of the method for manufacturing a chemically strengthened alkali-aluminosilicate glass described above, the ion-exchangeable glass composition is melted for up to about 6 hours at about 1690° C. According to several exemplary embodiments of the method for manufacturing a chemically strengthened alkali-aluminosilicate glass described above, the ion-exchangeable glass composition is melted for up to about 4 hours at about 1690° C. According to several exemplary embodiments of the method for manufacturing a chemically strengthened alkali-aluminosilicate glass described above, the ion-exchangeable glass composition is melted for up to about 2 hours at about 1690° C.

According to several exemplary embodiments of the method for manufacturing a chemically strengthened alkali-aluminosilicate glass described above, the ion exchangeable glass composition is annealed at a rate of about 1° C./hour until it reaches 570° C. The ion exchangeable glass composition is then cooled naturally until it reaches room temperature (or about 21° C.).

According to several exemplary embodiments, the ion exchangeable glass for producing chemically strengthened alkali-aluminosilicate glass described above is chemically strengthened according to conventional ion exchange conditions. According to several exemplary embodiments of the method for manufacturing a chemically strengthened alkali-aluminosilicate glass described above, the ion exchange process occurs in a molten salt bath. According to several exemplary embodiments, the molten salt is potassium nitrate (KNO₃).

According to several exemplary embodiments of the method for manufacturing a chemically strengthened alkali-aluminosilicate glass described above, the ion exchange treatment takes place at a temperature range of from about 390° C. to about 450° C. According to several exemplary embodiments of the method for manufacturing a chemically strengthened alkali-aluminosilicate glass described above, the ion exchange treatment takes place at about 420° C. According to several exemplary embodiments of the method for manufacturing a chemically strengthened alkali-aluminosilicate glass described above, the ion exchange treatment takes place at temperatures of at least about 420° C. According to several exemplary embodiments of the method for manufacturing a chemically strengthened alkali-aluminosilicate glass described above, the ion exchange treatment takes place at temperatures of up to about 420° C.

According to several exemplary embodiments of the method for manufacturing a chemically strengthened alkali-aluminosilicate glass described above, the one glass solution process is used. Thus, according to several exemplary embodiments, the ion exchangeable glass for producing chemically strengthened alkali-aluminosilicate glass is chemically strengthened before it is cut. According to several exemplary embodiments of the method for manufacturing a chemically strengthened alkali-aluminosilicate glass described above, the ion exchange treatment is conducted for up to about 6 hours. According to several exemplary embodiments of the method for manufacturing a chemically strengthened alkali-aluminosilicate glass described above, the ion exchange treatment is conducted for up to about 4 hours. According to several exemplary embodiments of the method for manufacturing a chemically strengthened alkali-aluminosilicate glass described above, the ion exchange treatment is conducted for up to about 2 hours. According to several exemplary embodiments of the method for manufacturing a chemically strengthened alkali-aluminosilicate glass described above, the ion exchange treatment is conducted for about 2 hours to about 6 hours. According to several exemplary embodiments of the method for manufacturing a chemically strengthened alkali-aluminosilicate glass described above, the ion exchange treatment is conducted for about 2 hours to about 4 hours.

According to several exemplary embodiments of the chemically strengthened alkali-aluminosilicate glass described above, the glass has a surface compressive stress layer having a compressive stress of at least about 750 MPa. According to several exemplary embodiments of the chemically strengthened alkali-aluminosilicate glass described above, the glass has a surface compressive stress layer having a compressive stress of at least about 850 MPa. According to several exemplary embodiments of the chemically strengthened alkali-aluminosilicate glass described above, the glass has a surface compressive stress layer having a compressive stress of at least about 950 MPa. According to several exemplary embodiments of the chemically strengthened alkali-aluminosilicate glass described above, the glass has a surface compressive stress layer having a compressive stress of at least about 1050 MPa. According to several exemplary embodiments of the chemically strengthened alkali-aluminosilicate glass described above, the glass has a surface compressive stress layer having a compressive stress of up to about 1200 MPa. According to several exemplary embodiments of the chemically strengthened alkali-aluminosilicate glass described above, the glass has a surface compressive stress layer having a compressive stress of from about 750 MPa to about 1200 MPa.

According to several exemplary embodiments of the chemically strengthened alkali-aluminosilicate glass described above, the glass has a surface compressive stress layer having a depth of at least about 30.0 μm. According to several exemplary embodiments of the chemically strengthened alkali-aluminosilicate glass described above, the glass has a surface compressive stress layer having a depth of at least about 35.0 μm. According to several exemplary embodiments of the chemically strengthened alkali-aluminosilicate glass described above, the glass has a surface compressive stress layer having a depth of at least about 40.0 μm. According to several exemplary embodiments of the chemically strengthened alkali-aluminosilicate glass described above, the glass has a surface compressive stress layer having a depth of at least about 45.0 μm. According to several exemplary embodiments of the chemically strengthened alkali-aluminosilicate glass described above, the glass has a surface compressive stress layer having a depth of from about 30.0 μm to about 45.0 μm.

According to several exemplary embodiments of the chemically strengthened alkali-aluminosilicate glass described above, the glass has a central tension of up to about 40 MPa. According to several exemplary embodiments of the chemically strengthened alkali-aluminosilicate glass described above, the glass has a central tension of up to about 50 MPa. According to several exemplary embodiments of the chemically strengthened alkali-aluminosilicate glass described above, the glass has a central tension of up to about 60 MPa. According to several exemplary embodiments of the chemically strengthened alkali-aluminosilicate glass described above, the glass has a central tension of up to about 70 MPa. According to several exemplary embodiments of the chemically strengthened alkali-aluminosilicate glass described above, the glass has a central tension of from about 40 MPa to about 70 MPa.

According to several exemplary embodiments of the chemically strengthened alkali-aluminosilicate glass described above, the glass is chemically strengthened by ion exchange treatment at a temperature of from about 390° C. to about 450° C. for about 2 to about 6 hours and the glass has: (1) a surface compressive stress layer having a compressive stress of at least about 750 MPa and the depth of the surface compressive stress layer is at least about 30 μm, (2) a central tension zone having a tensile stress of from about 40 MPa to about 70 MPa, and (3) a thickness of from about 0.1 mm to about 1.2 mm. According to several exemplary embodiments of the chemically strengthened alkali-aluminosilicate glass described above, the glass is chemically strengthened by ion exchange treatment at a temperature of from about 390° C. to about 450° C. for about 2 to about 4 hours and the glass has: (1) a surface compressive stress layer having a compressive stress of about 750 MPa to about 1200 MPa and the depth of the surface compressive stress layer is at about 30 μM to about 45 μm, (2) a central tension zone having a tensile stress of from about 60 MPa to about 70 MPa and (3) a thickness of from about 0.4 mm to about 0.7 mm.

According to several exemplary embodiments of the chemically strengthened alkali-aluminosilicate glass described above, the glass has a density of up to about 2.5 g/cm³ and a linear coefficient of expansion α₂₅₋₃₀₀ 10⁻⁷/° C. in a range of from about 90.0 to about 105.0.

According to several exemplary embodiments of the chemically strengthened alkali-aluminosilicate glass described above, the glass may be used as a protective glass in applications such as solar panels, refrigerator doors, and other household products. According to several exemplary embodiments of the chemically strengthened alkali-aluminosilicate glass described above, the glass may be used as a protective glass for televisions, as safety glass for automated teller machines, and additional electronic products. According to several exemplary embodiments of the chemically strengthened alkali-aluminosilicate glass described above, the glass may be used as cover glass for consumer mobile electronic devices such as smart phones, tablets and note pads. The glass may also be used in applications such as automobile windshields and as the substrate for architectural smart windows. According to several exemplary embodiments of the chemically strengthened alkali-aluminosilicate glass described above, the glass may be used as a touch screen or touch panel due to its high strength.

The following examples are illustrative of the compositions and methods discussed above.

### Examples

An ion-exchangeable glass composition that included the components shown below in Table 1 was prepared as follows:

TABLE 1

| Oxide | Mol % |
|---|---|
| SiO₂ | 66.0 |
| Al₂O₃ | 15.1 |
| Na₂O | 14.9 |
| B₂O₃ | 2.0 |
| K₂O | 0 |
| MgO | 2.0 |
| CaO | 0 |

Batch materials, as shown in Table 2 were weighed and mixed before being added to a 2 liter plastic container. The batch materials used were of chemical reagent grade quality.

TABLE 2

| Batch raw materials | Batch weight (gm) |
|---|---|
| Sand | 334.3 |
| Alumina hydroxide | 190.1 |
| Soda ash | 136.7 |
| Borax | 21.7 |
| Potassium carbonate | 0 |
| Magnesia | 6.42 |
| Limestone | 0 |

The particle size of the sand was between 0.045 and 0.25 mm. A tumbler was used for mixing the raw materials to make a homogenous batch as well as to break up soft agglomerates. The mixed batch was transferred from the plastic container to an 800 ml. platinum-rhodium alloy crucible for glass melting. The platinum-rhodium alloy crucible was placed in an alumina backer and loaded in a high temperature furnace equipped with MoSi heating elements operating at a temperature of 900° C. The temperature of the furnace was gradually increased to 1690° C. and the platinum-rhodium alloy crucible with its backer was held at this temperature for 4 hours. The glass sample was then formed by pouring the molten batch materials from the platinum-rhodium allow crucible onto a stainless steel plate to form a glass patty. While the glass patty was still hot, it was transferred to an annealer and held at a temperature of 630° C. for 2 hours and was then cooled at a rate of 1° C./min. to 570° C. After that, the sample was cooled naturally to room temperature (21° C.).

The glass sample was then chemically strengthened by placing it in a molten salt bath tank, in which the constituent sodium ions in the glass were exchanged with externally supplied potassium ions at a temperature of 420° C. which was less than the strain point of the glass for 4 hours. By this method, the glass sample was strengthened by ion exchange to produce a compressive stress layer at the treated surface.

The measurement of the compressive stress at the surface of the glass and the depth of the compressive stress layer (based on double refraction) were determined by using a polarization microscope (Berek compensator) on sections of the glass. The compressive stress of the surface of the glass was calculated from the measured dual refraction assuming a stress-optical constant of 0.26 (nm*cm/N) (Scholze, H., Nature, Structure and Properties, Springer-Verlag, 1988, p. 260).

The results for the composition shown in Table 1 above are shown below in Table 3 in the column designated as “Ex. 1”. Additional compositions shown in Tables 3 and 4 and designated as “Ex. 2” to “Ex. 14” were prepared in a similar manner as described above for the composition designated as Ex. 1.

TABLE 3

| Oxide (mol %) | Ex. 1 | Ex. 2 | Ex. 3 | Ex. 4 | Ex. 5 | Ex. 6 | Ex. 7 |
|---|---|---|---|---|---|---|---|
| SiO₂ | 66.0 | 64.0 | 64.0 | 64.0 | 63.9 | 63.4 | 63.4 |
| Al₂O₃ | 15.1 | 15.1 | 15.1 | 15.1 | 15.0 | 15.2 | 15.2 |
| Na₂O | 14.9 | 13.9 | 12.9 | 11.9 | 13.0 | 13.2 | 12.2 |
| B₂O₃ | 2.0 | 2.0 | 2.0 | 2.0 | 2.0 | 4.2 | 4.2 |
| K₂O | 0 | 3.0 | 4.0 | 4.0 | 2.8 | 2.8 | 3.3 |
| MgO | 2.0 | 2.0 | 2.0 | 3.0 | 2.0 | 0 | 0.5 |
| CaO | 0 | 0 | 0 | 0 | 1.2 | 1.2 | 1.2 |
| Al₂O₃ + B₂O₃ + Na₂O | 32.0 | 31.0 | 30.0 | 29.0 | 30.1 | 32.6 | 31.6 |
| (B₂O₃ + Na₂O + K₂O)/Al₂O₃ | 1.1 | 1.3 | 1.3 | 1.2 | 1.2 | 1.3 | 1.3 |
| (B₂O₃ + CaO)/MgO | 1.1 | 1.1 | 1.1 | 0.7 | 1.7 | ∞ | 10.8 |
| d (g/cm³) | 2.46 | 2.44 | 2.43 | 2.44 | 2.44 | 2.42 | 2.43 |
| n_{D} (20° C.) | 1.496 | 1.499 | 1.497 | 1.501 | 1.502 | 1.504 | 1.504 |
| α (×10⁻⁷/° C.) | 89.5 | 97.4 | 105.2 | 101.7 | 99.9 | 98.3 | 95.4 |
| T_{10e2.5} (316 poise) | 1692 | 1663 | 1674 | 1682 | 1641 | 1658 | 1665 |
| T_{w} | 1338 | 1316 | 1322 | 1332 | 1308 | 1312 | 1320 |
| T_{liq} | 970 | 1025 | 1010 | 1040 | 1005 | 980 | 990 |
| T_{soft} | 903 | 887 | 898 | 901 | 882 | 872 | 878 |
| Tₐ | 648 | 634 | 639 | 643 | 632 | 635 | 640 |
| Tₛ | 602 | 589 | 592 | 599 | 586 | 590 | 593 |
| Young's Modulus (MPa) | 70.90 | 70.33 | 70.00 | 69.62 | 70.10 | 70.12 | 69.88 |
| Shear Modulus (MPa) | 30.29 | 29.84 | 29.70 | 29.57 | 29.76 | 29.79 | 29.64 |
| Poisson's Ratio | 0.172 | 0.178 | 0.178 | 0.177 | 0.178 | 0.176 | 0.179 |
| VH (kgf/mm²) | 567 | 550 | 553 | 557 | 555 | 546 | 550 |
| VHCS (kgf/mm²) | 657 | 653 | 625 | 625 | 668 | 646 | 654 |
| CS (MPa) | 1204 | 988 | 910 | 928 | 1084 | 951 | 953 |
| DOL (μm) | 31.3 | 40 | 44.0 | 43.0 | 30.0 | 30 | 30.6 |
| CT (MPa) | 64 | 59 | 66 | 67 | 51 | 43 | 46 |

TABLE 4

| Oxide (mol %) | Ex. 8 | Ex. 9 | Ex. 10 | Ex. 11 | Ex. 12 | Ex. 13 | Ex. 14 |
|---|---|---|---|---|---|---|---|
| SiO₂ | 64.2 | 64.9 | 65.8 | 63.1 | 64.0 | 63.3 | 63.4 |
| Al₂O₃ | 14.1 | 14.4 | 14.2 | 14.1 | 14.2 | 14.2 | 14.5 |
| Na₂O | 11.5 | 10.4 | 10.5 | 13.4 | 14.8 | 13.9 | 14.1 |
| B₂O₃ | 4.1 | 4.1 | 5.1 | 2.3 | 2.5 | 2.1 | 2.6 |
| K₂O | 4.4 | 4.4 | 4.4 | 4.4 | 4.1 | 4.5 | 4.1 |
| MgO | 1.7 | 1.7 | 0 | 2.5 | 0.4 | 2.0 | 1.3 |
| CaO | 0 | 0 | 0 | 0.2 | 0 | 0 | 0 |
| Al₂O₃ + B₂O₃ + Na₂O | 29.7 | 28.9 | 29.8 | 29.8 | 31.5 | 30.5 | 31.2 |
| (B₂O₃ + Na₂O + K₂O)/Al₂O₃ | 1.4 | 1.3 | 1.4 | 1.4 | 1.5 | 1.5 | 1.4 |
| (B₂O₃ + CaO)/MgO | 2.4 | 2.4 | ∞ | 1.0 | 6.3 | 1.1 | 2.0 |
| d (g/cm³) | 2.42 | 2.41 | 2.41 | 2.45 | 2.43 | 2.45 | 2.44 |
| n_{D} (20° C.) | 1.502 | 1.499 | 1.501 | 1.500 | 1.502 | 1.490 | 1.495 |
| α (×10⁻⁷/° C.) | 102.6 | 96.3 | 92.8 | 100.2 | 102.3 | 101.5 | 100.8 |
| T_{10e2.5} (316 poise) | 1643 | 1672 | 1685 | 1618 | 1626 | 1622 | 1630 |
| T_{w} | 1307 | 1326 | 1305 | 1274 | 1258 | 1261 | 1268 |
| T_{liq} | 985 | 960 | 970 | 1010 | 970 | 995 | 985 |
| T_{soft} | 863 | 888 | 841 | 860 | 854 | 855 | 863 |
| Tₐ | 596 | 609 | 591 | 598 | 593 | 595 | 601 |
| Tₛ | 557 | 566 | 552 | 554 | 546 | 548 | 552 |
| Young's Modulus (MPa) | 70.17 | 70.22 | 70.04 | 69.10 | 69.60 | 69.50 | 69.80 |
| Shear Modulus (MPa) | 29.66 | 29.73 | 29.66 | 29.30 | 29.50 | 29.42 | 29.60 |
| Poisson's Ratio | 0.183 | 0.181 | 0.181 | 0.178 | 0.180 | 0.181 | 0.179 |
| VH (kgf/mm²) | 549 | 532 | 556 | 553 | 546 | 555 | 558 |
| VHCS (kgf/mm²) | 640 | 663 | 628 | 646 | 643 | 675 | 635 |
| CS (MPa) | 869 | 837 | 793 | 805 | 821 | 810 | 842 |
| DOL (μm) | 37.2 | 41.7 | 40 | 44.3 | 43.5 | 48.0 | 41.0 |
| CT (MPa) | 52 | 57 | 50 | 59.4 | 58.3 | 64.4 | 55.9 |

The definitions of the symbols set forth in Tables 3 and 4 are as follows:
d: density (g/ml), which is measured with the Archimedes method (ASTM C693);
n_{D}: refractive index, which is measured by refractometry;
a: coefficient of thermal expansion (CTE) which is the amount of linear dimensional change from 25 to 300° C., as measured by dilatometry;
T_{10e2.5}: the temperature at the viscosity of 10^{2.5} poise, as measured by high temperature cylindrical viscometry;
T_{w}: glass working temperature at the viscosity of 10⁴ poise;
T_{liq}: liquidus temperature where the first crystal is observed in a boat within a gradient temperature furnace (ASTM C829-81), generally test is 72 hours for crystallization;
T_{soft}: glass softening temperature at the viscosity of 10^{7.6} poise as measured by the fiber elongation method;
Tₐ: glass annealing temperature at the viscosity of 10¹³ poise as measured by the fiber elongation method;
Tₛ: glass strain temperature at the viscosity of 10^{14.5} poise and measured by the fiber elongation method;
VH: Vicker's Hardness;
VH_{cs}: Vicker's Hardness after chemical strengthening;
CS: compressive stress (in-plane stress which tends to compact the atoms in the surface);
DOL: depth of layer which represents the depth of compression below the surface to the nearest zero stress plane; and
CT: central tension

While the present invention has been described in terms of certain embodiments, those of ordinary skill in the art will recognize that the invention can be practiced with modification within the spirit and scope of the appended claims.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

The present disclosure has been described relative to certain embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. An ion-exchangeable glass for producing chemically strengthened alkali-aluminosilicate glass having a composition comprising in mol % on an oxide basis:
from about 63.0% to about 68.0% of SiO₂;
from about 12.0% to about 16.0% of Al₂O₃;
from about 10.0% to about 15.0% of Na₂O;
from about 2.0% to about 6.0% of B₂O₃;
from about 0% to about 6.0% of K₂O;
from about 0% to about 3.0% of MgO; and
from about 0% to about 1.5% of CaO;
wherein 28% is <Al₂O₃+B₂O₃+Na₂O<33%;
wherein (B₂O₃+Na₂O+K₂O)/Al₂O₃ is >1; and
wherein (B₂O₃+CaO)/MgO is ≥1.

2-5. (canceled)

6. The ion-exchangeable glass according to claim 1, wherein the glass has a liquidus temperature of from about 950° C. to about 1100° C.

7. A chemically strengthened alkali-aluminosilicate glass made from an ion-exchangable glass having a composition comprising in mol % on an oxide basis:
from about 63.0% to about 68.0% of SiO₂;
from about 12.0% to about 16.0% of Al₂O₃;
from about 10.0% to about 15.0% of Na₂O;
from about 2.0% to about 6.0% of B₂O₃;
from about 0% to about 6.0% of K₂O;
from about 0% to about 3.0% of MgO; and
from about 0% to about 1.5% of CaO;
wherein 28% is <Al₂O₃+B₂O₃+Na₂O<33;
wherein (B₂O₃+Na₂O+K₂O)/Al₂O₃ is >1; and
wherein (B₂O₃+CaO)/MgO is ≥1;
wherein the glass is ion-exchanged and has a surface compressive stress layer and a central tension zone;
wherein the surface compressive stress layer has a compressive stress of at least about 750 MPa and a depth of at least about 30.0 μm;
wherein the central tension zone has a tensile stress of from about 40 MPa to about 70 MPa; and
wherein the glass has a thickness of from about 0.1 mm to about 1.2 mm.

8. The chemically strengthened alkali-aluminosilicate glass according to claim 7, wherein the surface compressive stress layer has a compressive stress of from about 750 MPa to about 1200 MPa and a depth of from about 30 μm to about 45 μm;
wherein the central tension zone has a tensile stress of from about 60 MPa to about 70 MPa; and
wherein the glass has a thickness of from about 0.4 mm to about 0.7 mm.

9-12. (canceled)

13. The chemically strengthened alkali-aluminosilicate glass according to claim 7, wherein the surface compressive stress layer has a compressive stress of from about 750 MPa to about 1200 MPa.

14-16. (canceled)

17. The chemically strengthened alkali-aluminosilicate glass according to claim 7, wherein the depth of the surface compressive stress layer is from about 30.0 μm to about 45.0 μm.

18-20. (canceled)

21. The chemically strengthened alkali-aluminosilicate glass according to claim 7, wherein the central tension zone has a central tension of from about 40 MPa to about 70 MPa.

22. The chemically strengthened alkali-aluminosilicate glass according to claim 7, wherein the glass has a density of up to about 2.5 g/cm³.

23. The chemically strengthened alkali-aluminosilicate glass according to claim 7, wherein the glass has a linear coefficient of expansion (α₂₅₋₃₀₀ 10⁻⁷/° C.) of from about 90.0 to about 105.0.

24. A method for producing a chemically strengthened alkali-aluminosilicate glass, comprising:
mixing and melting glass raw material components to form a homogenous glass melt composition comprising in mol % on an oxide basis:
from about 63.0% to about 68.0% of SiO₂;
from about 12.0% to about 16.0% of Al₂O₃;
from about 10.0% to about 15.0% of Na₂O;
from about 2.0% to about 6.0% of B₂O₃;
from about 0% to about 6.0% of K₂O;
from about 0% to about 3.0% of MgO; and
from about 0% to about 1.5% of CaO;
wherein 28% is <Al₂O₃+B₂O₃+Na₂O<33%;
wherein (B₂O₃+Na₂O+K₂O)/Al₂O₃ is ≥1; and
wherein (B₂O₃+CaO)/MgO is ≥1;
shaping the glass using a method selected from the overflow down-draw method, the floating method and combinations thereof;
annealing the glass; and
chemically strengthening the glass by ion exchange at a temperature of from about 390° C. to about 450° C. for about 2 hours to about 6 hours.

25. The method of claim 24, further comprising cutting the glass after the chemically strengthening.

26. The method of claim 24, wherein the glass raw material components are melted for up to about 12 hours at a temperature of about 1690° C.

27. The method of claim 24, wherein the glass raw material components are melted for up to about 6 hours at a temperature of about 1690° C.

28. The method of claim 27, wherein the glass raw material components are melted for up to about 4 hours at a temperature of about 1690° C.

29. The method of claim 28, wherein the glass raw material components are melted for up to about 2 hours at a temperature of about 1690° C.

30. The method of claim 24, wherein the glass is annealed at a rate of about 1° C./hour.

31. The method of claim 24, wherein the glass is chemically strengthened by ion exchange in a molten salt bath.

32. The method of claim 31, wherein the molten salt is KNO₃.

33. The method of claim 24, wherein the glass is chemically strengthened by ion exchange at a temperature of about 420° C.

34-37. (canceled)

38. The method of claim 24, wherein the glass is chemically strengthened by ion exchange for about 2 hours to about 4 hours.
